(19) United States
(12) Patent Application Publication
(10) Pub. No.: US 2016/0058082 A1
(43) Pub. Date: Mar. 3, 2016

(54) HAND AND ANIMAL LEASH COVER

(71) Applicant: LAWRENCE STONE, MUKILTEO, WA (US)

(72) Inventor: LAWRENCE STONE, MUKILTEO, WA (US)

(21) Appl. No.: 14/843,827

(22) Filed: Sep. 2, 2015

Related U.S. Application Data
(60) Provisional application No. 62/044,503, filed on Sep. 2, 2014.

(51) Int. Cl. A41D 19/00; A01K 27/00; A41D 19/01; A01K 29/00

(52) U.S. Cl. CPC A41D 19/0013; A01K 29/00; A01K 27/003; A41D 19/01; A41D 19/0044; A41D 19/0034

(57) ABSTRACT

A hand and animal leash cover that includes a glove-shaped outer shell configured to surround an individual's hand while holding a leash retracting device or the loop on a standard leash with the middle section of the leash extending forward and attaching to the neck or harness on an animal. The outer shell includes a front leash opening with a diameter slightly larger than the clip or buckle connector attached the distal end of the leash. Also formed on the outer shell opposite the core opening is a wrist opening. Formed or attached around the wrist opening is a hand strap that allows the user to grasp the outer shell with the opposite free hand, and an elastic band that closely conforms the wrist opening to the user's wrist. The leash cover includes an optional wrist strap and tether that allows the user to release his or her grip on the retracting device and remove his hand from the outer shell to pickup or manipulate other objects and still use the arm to restrain the leash and control the animal.

This utility patent application is based upon and claims the filing date benefit of U.S. provisional patent application (Application No. 62/044,503) filed on Sep. 2, 2014.

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

1. Field of the Invention

This invention pertains to covers for a hand and more particularly, to such covers configured to be worn around the hand gripping a leash retracting device or the hand loop on a standard loop that is used to walk an animal.

2. Description of the Related Art

Dog walkers often walk their dogs on leashes in wet or cold weather. Because the ends of the leashes are held by the walkers' hands, the hands and fingers are exposed and become cold. While some walkers wear gloves to keep their hands and fingers warm, dogs often defecate on the walk which require walkers to remove their gloves in order to pick-up the excrement in a plastic bag. Unfortunately, the combined tasks of restraining a dog that is more interested in continuing its walk, removing gloves from the hands, and picking-up excrement on the ground and carefully placing it into a plastic bag can be challenging.

Retractable dog leashes include a flexible strap attached at one end to a spool located inside a rigid housing containing a spring rewind mechanism. A locking lever is mounted on the housing that allows the user to selective lock and unlocks the rewind mechanism. The housing is relatively narrow includes an exit port on its front surface that the leash extends through. A hand grip is formed on the rear surface of the housing opposite the exit port that enables the user to hold the housing using all five fingers aligned in a ‘pistol grip’ with the leash extending forward and substantially aligned with the user's forearm to reduce fatigue. The loop on the leash, the housing and the hand grip are sold in different sizes for different size dogs. When a glove is worn on the hand holding the housing, the size and thickness of the glove may prevent the user from securely gripping the hand grip with all five fingers or prevent manipulation of the locking lever.

What is needed is a protective cover that temporarily fits over and surrounds the user's hand holding the end of a retracting device or the hand loop formed on the end of a leash with the opposite end of the leash attached to an animal. What is also needed is a protective cover that allows the leash to extend from the cover at an angle substantially aligned with the user's forearm to reduce arm and wrist fatigue. What is also needed is such a protective cover that allows the user to temporarily release his or her grip on the retracting device or hand loop still restrain the dog with the user's arm.

### SUMMARY OF THE INVENTION

The above needs are met by a hand and animal leash cover disclosed herein that includes a glove-shaped outer shell configured to surround an individual's hand while holding a leash retracting device or while holding the hand loop end of a leash that attaches at its opposite end to the neck or harness on an animal. The outer shell includes a front leash opening with a diameter slightly larger than a clip or buckle connector attached to the distal end of the leash. The front leash opening is formed on the outer shell's front surface and is smaller than the leash restraining device or a collapsed hand loop formed on a leash thereby preventing the leash from detached from the outer shell if the retracting device or the hand loop is released and the leash is pulled forward.

Formed on the outer shell opposite the front leash opening is a wide wrist opening. Formed or attached around the wrist opening is an optional elastic band that causes the wrist opening to automatically close and conform to the user's wrist to reduce heat lost.

The leash cover also includes an outer hand strap located near the wrist opening. The outer hand strap is transversely aligned and extends at least partially around the outer shell. During use, the user places his or her dominant hand inside the outer shell and tightly grips the leash restraining device or the hand loop on the leash. When the dominant hand is needed to pick up or hold other objects when walking an animal, the user may use his opposite free hand and temporarily grasp the outer hand strap to hold and restrain the outer shell containing the leash restraining device. The dominant hand may then release the lease restraining device or the hand loop and may be removed and returned to the outer shell as needed.

The leash cover may also include an optional wrist strap and tether that extends between the wrist strap and the outer shell that couples the outer shell to the walker's arm which allows the walker to release his or her grip on the restraining device and remove his or her hand from the outer shell to pickup or manipulate other objects with the hand and still restrain the leash and control the animal with the arm.

### DESCRIPTION OF THE DRAWINGS

FIG. 1 is a side elevational view of a hand and leash cover showing an animal walker gripping the handle on a retractable leash with the leash extending forward through a front leash opening.

FIG. 2 is a front elevational view of the leash cover shown in FIG. 1.

FIG. 3 is a sectional, side elevational view of the leash cover taken along line 3-3 in FIG. 1.

FIG. 4 is an anterior, side elevational view of a hand and leash cover showing an animal walker gripping the loop end on a standard leash with the middle section of the leash extending forward through a front leash opening.

FIG. 5 is a dorsal side elevational view of a hand and leash cover shown in FIG. 4.

### DESCRIPTION OF THE PREFERRED EMBODIMENT(S)

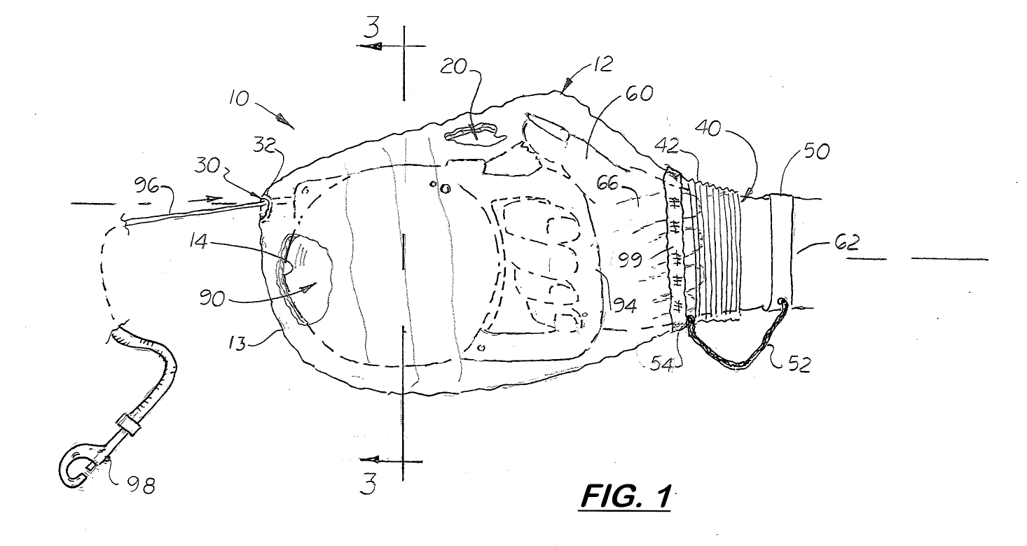

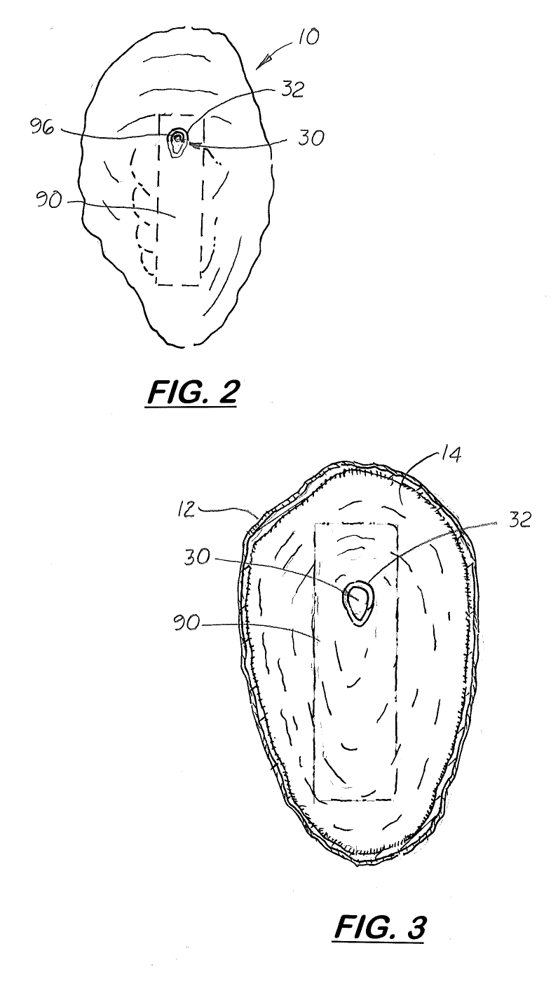

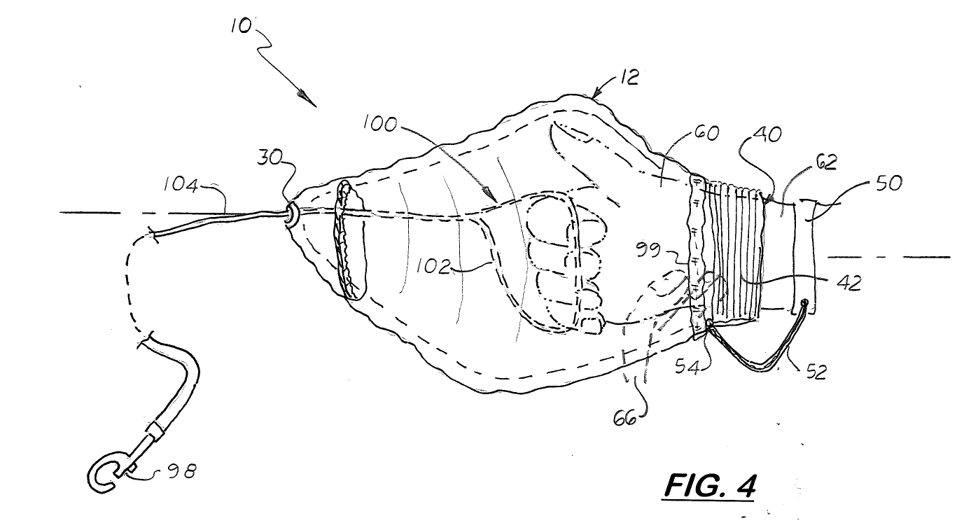

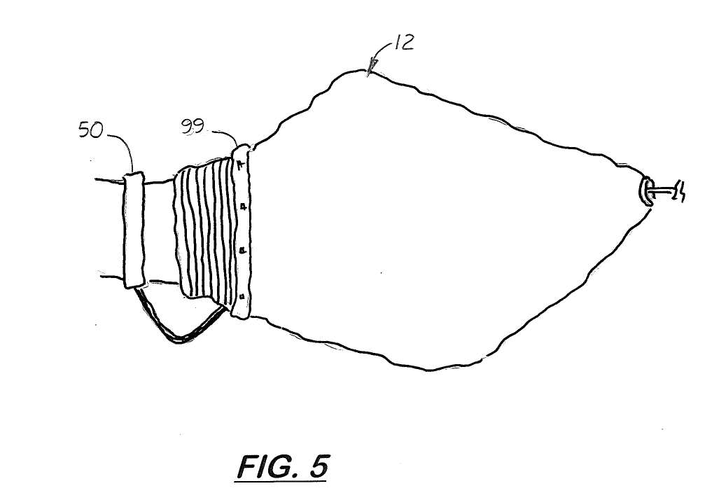

In the accompanying FIGS. 1-5 there is shown a hand and animal leash cover 10 that includes a glove-shaped outer shell 12 configured to surround an individual's hand 60 while holding a leash retracting device 90 with a forward extending leash 96 that includes a clip connector 98 at its distal end that attaches to the neck or harness on an animal (not shown). FIG. 4 shows the individual hand 60 inserted into the outer shell 12 and holding the hand loop 102 formed on a leash 104.

The outer shell 12 includes a front leash opening 30 with a fixed, non-expandable diameter slightly larger than the clip connector 98 attached the distal end of the leash 96 or 104. Surrounding the leash opening 30 is an elastic ring 32 that allows the front leash opening 30 to shrink and selectively close around a leash 96 or 104. Also, formed on the outer shell 12 opposite the leash opening 30 is a wide wrist opening 40. Formed or attached around the wrist opening 40 is an optional elastic band 42 that enables the wrist opening 40 to close and automatically conform to the user's wrist 62 to reduce heat lost.

The leash cover 10 also includes an outer hand strap 99 located near the wrist opening 40. The hand strap 99 is aligned transversely completely around the outer shell 12 as shown in FIGS. 4 and 5. It should be understood that the hand strap 99 may extend partially around the outer shell 12. During use, the user places his or her dominant hand 60 inside the leash cover 10 and holds the leash restraining device 90 or hand loop 102. When the dominant hand 60 is needed to pick up or hold other objects when walking an animal, the user may use his opposite free hand 66 and temporarily grasp the hand strap 99 to hold the outer shell 12 in place on the arm 90 while still containing the restraining device 90 or hand loop 102. The dominant hand 60 may then be removed from and then returned to the outer shell 12 and grasp the leash restraining device 90 or hand loop 102 as needed.

The leash cover 10 includes an optional wrist strap 50 and tether 52 that extends between the wrist strap 50 and a connector 54 on the outer shell 12 that allows the user to release his or her grip on the handle 94 on the retracting device 90 or the hand loop 102 on a standard leash 100, 104, respectively, and remove his hand 60 from the outer shell 12 and still use the wrist 62 and forearm to restrain the leash 96 or leash 100 and control the animal.

In one embodiment, the outer shell 12 is made of thin, flexible natural fabric, such as cotton or wool, or synthetic fabrics, such as nylon, polyethylene, polyurethane coated nylon, or a combination thereof. The outer shell 12 may include an optional insulation inner layer 14 to provide additional warmth.

The size of the outer shell 12 can vary to accommodate the shape of the leash retraining device 90 and the user's hand or glove. In the embodiments shown in the Figs. the outer shell 12 measures approximate 8 to 12 inches in length and 6 to 10 inches in height, and 4 to 8 inches in width. The leash opening 30 is approximately ¼ to ¾ inches in diameter. The wrist opening 40 is approximately 4 to 8 inches in diameter. The tether 52 is approximately 1 to 6 inches in length.

The hand strap 99 may be an elastic strap and attached at two ends to the outer shell 12. The hand strap 99 may be sufficient in length to extend partially or completely round the outer shell 12.

During use, the user's dominate hand 60 grips the handle 92 and holds the retracting device 90 with the front surface 91 adjacent to the wrist opening 40. The leash 96 is then pulled and the end connector 98 attached the distal end of the leash 96 is extended through the leash opening 30. The leach 96, 104, is pulled through forward so that the end connector 98 is then attached to the dog collar or harness. The restaining device or hand loop are located inside the outer shell 14. The wrist strap 50 is then attached to the user's arm.

When the user's dominate hand 60 is needed to hold another object or to pickup excrement, the user grips the outer hand strap 99 and the dominate hand 60 then released the and pulled out of the outer shell 12. The wrist strap 50 and tether 52 remain attached to the wrist 62 allowing the user restrain the dog with the wrist and arm.

In addition to allowing the user to easily remove the hand from the outer shell and still retain the animal with the arm, another important feature of the invention is that the front leash opening 30 is located on front surface 13 of the outer shell 12 and substantially aligned with the longitudinally axis of the user's wrist or forearm. This allows the leash to be held with the wrist partially locked and the arm partially extending downward and forward and longitudinally aligned with the longitudinally axis of the leash when attached to the animal which is less fatiguing to the user.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

I claim:

1. A leash cover for a hand holding the retracting housing or the hand loop on an animal leash with end connector that attaches to an animal when walking the animal, the cover comprising:
a. an outer shell configured to surround an individual's hand holding the retractable housing or hand loop while waking the animal, said outer shell includes a front surface and an outer surface;
b. a wrist opening formed on said outer shell opposite said front surface;
c. a front leash opening formed on the front surface of the outer shell, said front leash opening configured large to allow said end connector connected to said leash to slide through said outer cover and extend forward from said leash opening and sufficiently small to block said retracting housing or hand loop from being passing through front leash opening;
d. a hand strap attached to the outer shell; and
e. an elastic band formed around the wrist opening that enables the wrist opening to closely conform to the user's wrist to reduce heat lost.

2. The cover as recited in claim 1, further including a wrist strap and a tether that connects at one end to the wrist strap and at an opposite end to the outer shell.

3. The cover as recited in claim 1, further including an insulation layer inside the outer shell.
